(19) United States
(12) Patent Application Publication
(10) Pub. No.: US 2009/0149161 A1
(43) Pub. Date: Jun. 11, 2009

(54) Method for transmitting and receiving data to prepare for poor power supply and terminal using the same

(75) Inventor: Ji-Hoon Kang, Seoul (KR)

Correspondence Address: DOCKET CLERK, P.O. DRAWER 800889, DALLAS, TX, 75380, US

(73) Assignee: SAMSUNG ELECTRONICS CO., LTD, Suwon-si (KR)

(21) Appl. No.: 12/286,595

(22) Filed: Oct. 1, 2008

(30) Foreign Application Priority Data
Dec. 5, 2007 (KR) 2007-0125436

(51) Int. Cl. H04M 3/42; H04M 3/00

(52) U.S. Cl. 455/414.1; 455/418

(57) ABSTRACT

A method for transmitting and receiving data to prepare for a poor power supply and a terminal using the same are provided. Data is transmitted and received to configure a user interface using data provided by a mobile communication service provider. During a data transmission and reception process, a problem occurring due to the poor power supply can be prevented in advance by recording a flag indicating a progress status. A terminal user does not need to perform an additional refresh operation for receiving the data even when the power supply of the terminal is abnormal during data transmission and reception and the terminal reboots. Interrupted data can be automatically transmitted and received by reading the recorded flag. The data transmission and reception process interrupted by the poor power supply can be smoothly resumed, thereby providing convenience for the user.

### CROSS-REFERENCE TO RELATED APPLICATION(S) AND CLAIM OF PRIORITY

The present application claims the benefit under 35 U.S.C. §119(a) from an application entitled “METHOD FOR TRANSMITTING AND RECEIVING DATA TO PREPARE FOR POOR POWER SUPPLY AND TERMINAL USING THE SAME” filed in the Korean Intellectual Property Office on Dec. 5, 2007 assigned Serial No. 2007-0125436, the entire contents of which are hereby incorporated herein by reference.

### TECHNICAL FIELD OF THE INVENTION

The present invention relates to a method and a terminal using the same that can automatically receive interrupted data without a special input operation by a user upon rebooting the terminal after a data reception process of the terminal is abnormally stopped due to a poor power supply when the terminal receives data from a server of a mobile communication provider.

### BACKGROUND OF THE INVENTION

Recently, a communication provider of a T-mobile company in the United States has introduced a user interface service called myFaves. The myFaves service is a user interface service based on data indicating that people often make the maximum number of calls (65%) to five selected people. In the myFaves service, five people registered by a mobile communication subscriber may be set in an idle screen of a terminal and the subscriber may communicate with the five people without any limitation of call rate expenses.

FIG. 1 illustrates an example of a user interface (UI) according to the myFaves service.

As illustrated in FIG. 1, when an icon 10 is selected to use the myFaves service in a terminal supporting the myFaves service, icons 11, 12, 13, 14, and 15 representing other parties or phone numbers (referred to as My Faves) are displayed on a terminal screen.

For example, the icons 12, 13, and 15 representing a friend, a partner, and the like frequently communicating with a terminal user may be registered and the mother icon 11 and the house icon 14 may be registered. The terminal user may make a call by selecting a specific icon among the icons 11 through 15 displayed on the screen. In the myFaves service currently being provided by the T-mobile company in the United States, a maximum of five people may be registered as My Faves. When a predetermined amount of money is paid, the communication fee for the registered phone numbers may be free or discounted at a given rate.

In a payment system of national mobile communication providers, there is a service of which the communication fee is free or discounted for a specific phone number designated by a mobile communication subscriber. However, in order to register the designated phone number, the subscriber has to visit a store of the mobile communication provider or has to access an Internet homepage thereof.

On the other hand, My Faves registered in the myFaves service may be changed by only manipulating the terminal and the communication fee for designated phone numbers may be free or discounted. Moreover, in the myFaves service, photos or images for icons for displaying My Faves may be edited. When a birthday, an anniversary, a profile, and the like for people registered as My Faves are recorded, content thereof may be displayed at a corresponding time or date. The myFaves service may provide a function capable of differentially designating ringtones for incoming calls from callers registered as My Faves.

As illustrated in FIG. 1, a method for displaying My Faves registered by the user may use the photos 12, 13, and 15, the character 11, and the simple image 14.

To provide this function, the T-mobile company provides a myFaves service protocol to terminal manufacturers and the terminal manufacturers specially manufacture terminals for the myFaves service according to the provided protocol.

FIG. 2 illustrates an example when a power supply is abnormal during data communication for the myFaves service.

When the above-described myFaves service is used, user interfaces to be displayed on the terminal are different according to a terminal user since other parties to which the user frequently makes a call are different according to the terminal user. Information regarding My Faves registered by the terminal user is stored in a server of a mobile communication provider. To discriminately provide data about My Faves differently registered according to the terminal user, a subscriber identification module (SIM) is used.

After the terminal subscriber joins the myFaves service, his or her SIM is inserted into the terminal. When the terminal is powered on, the terminal user receives data about My Faves already registered upon service subscription from the server of the mobile communication provider.

When the data about My Faves is normally transmitted, the photo, character, image, and the like are displayed as indicated by reference numerals 11, 14, and 15. Hourglass icons 20 and 21 are displayed at positions where My Faves are displayed if the power supply is abnormal during reception of the data about My Faves. Problems occurring when the hourglass icons 20 and 21 are generated will be described in detail with reference to FIG. 3.

FIG. 3 illustrates an example when the power supply is abnormal during reception of the data about My Faves.

When the terminal user turns on the power supply after inserting the SIM into the terminal, a Welcome message indicating that a connection to the server of the mobile communication provider has been established is received (S30). Upon determining that the connection to the server of the mobile communication provider has been established, the terminal transmits a Sync Command message for requesting the server of the mobile communication provider to establish a sync session (S31). Here, the term “sync” may refer to a process for receiving My Faves-related data stored in the server of the mobile communication provider.

In response to the sync session setup request from the terminal (S31), the server of the mobile communication provider transmits a SyncSrv message via a communication network such as a base station from the server of the mobile communication provider (S32). Since one SyncSrv message may contain information regarding two “My Faves” and five “My Faves” may be registered at maximum in the myFaves service currently being provided by the T-mobile company, three SyncSrv messages should be received. The SyncSrv message is transmitted in the form of a short message service (SMS), but is used as data for displaying My Faves-related content to the terminal without passing through a message content check process by the user, which is different from the conventional SMS message.

A process for displaying a user interface of the terminal by receiving the SyncSrv message requires more time than the processes S30 and S31. When the power supply is abnormal during reception of the SyncSrv message (S33), a process for receiving the SyncSrv message is interrupted (S34). When data about My Faves is not received due to reception interruption, the hourglasses are displayed as indicated by reference numerals 20 and 21 of FIG. 2.

Even when the terminal is powered on and reboots after the power supply is abnormal (S35), the hourglass icons 20 and 21 generated due to the reception interruption of the SyncSrv message do not disappear. For this reason, the user may not smoothly use the myFaves service.

To eliminate an error occurring in a process for receiving the SyncSrv message, a refresh item is provided in a menu of the terminal. When the refresh item is used (S36), the terminal retransmits the sync session setup request (S37), receives the SyncSrv message (S38), and completes synchronization between the terminal and the server of the mobile communication provider (S39).

If the refresh item is used as described above, a problem occurring when the SyncSrv message is not normally received due to a poor power supply can be eliminated. The T-Mobile service is a recently initiated service and the number of mobile communication subscribers of the myFaves service provided by the T-mobile company is small. Many customers lack an understanding of the myFaves service and many subscribers do not exactly know of the existence of a refresh menu and a use method thereof. Accordingly, from a point of view of the customers using the myFaves service, it is difficult to know that a problem occurred in a SyncSrv message reception process when an hourglass icon is displayed on the screen of the terminal and it is more difficult to address the problem using the refresh item.

Even if the terminal user reboots the terminal to address the problem when the hourglass icon is displayed on the terminal screen due to reception interruption of the SyncSrv message, the hourglass icon may be continuously displayed and therefore the user may be inconvenienced.

### SUMMARY OF THE INVENTION

To address the above-discussed deficiencies of the prior art, it is a primary object to provide a method that can normally implement a user interface of a terminal by receiving interrupted data without special manipulation of a user when data reception is stopped due to a problem of a poor power supply or the like during data reception for employing a service when the user interface of the terminal is implemented by receiving data provided from a mobile communication provider as in a myFaves service provided by a T-mobile company in the United States.

According to an aspect of the present invention, there is provided a method for transmitting and receiving data to prepare for a poor power supply of a terminal configuring a user interface by referring to data provided by a mobile communication provider, including the steps of: recording a status flag indicating that data request signal transmission is in progress when a data request signal required to configure the user interface is transmitted; and retransmitting the data request signal by reading the status flag and receiving requested data when the power supply of the terminal is interrupted and resumed during data reception in response to the data request signal.

The status flag may be recorded in a memory area that is not erasable even when the terminal is powered off.

The recorded status of the status flag may be changed by reflecting a data reception completion state when the requested data is completely received.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a user interface according to a myFaves service;

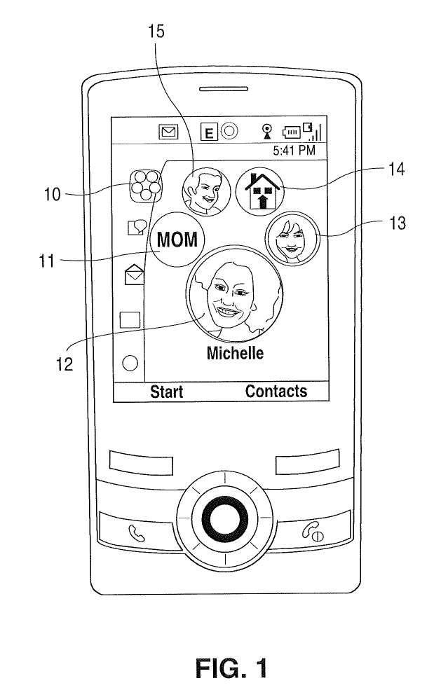

FIG. 2 illustrates an example when a power supply is abnormal during data communication for the myFaves service;

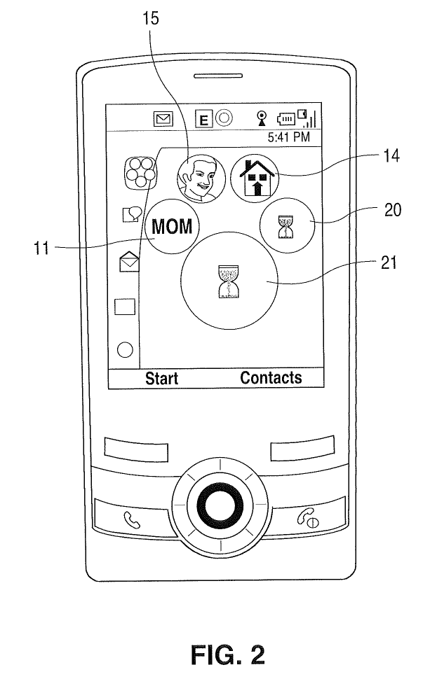

FIG. 3 illustrates an example when the power supply is abnormal during reception of My Faves-related data;

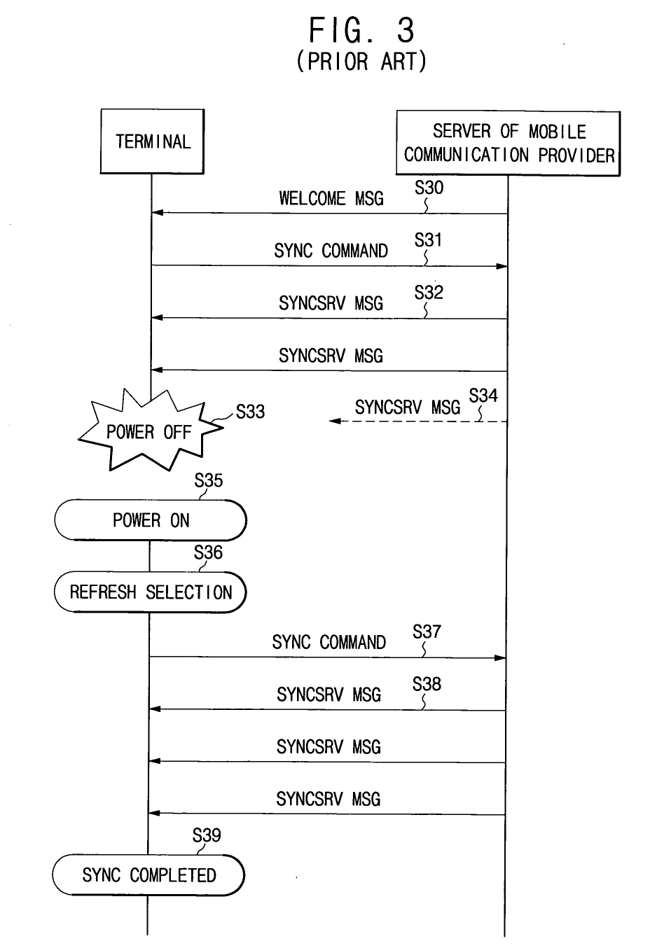

FIG. 4 is a schematic block diagram of a terminal according to an exemplary embodiment of the present invention;

FIG. 5 is a flowchart illustrating a method for transmitting and receiving data to prepare for a poor power supply according to an exemplary embodiment of the present invention; and

FIG. 6 illustrates an example when the power supply is abnormal during reception of My Faves-related data according to an exemplary embodiment of the present invention.

### DETAILED DESCRIPTION OF THE INVENTION

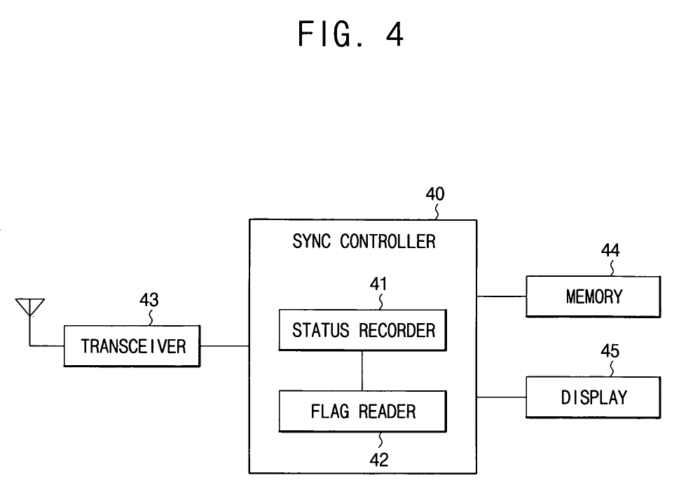

FIGS. 4 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication system.

FIG. 4 is a schematic block diagram of a terminal according to an exemplary embodiment of the present invention.

As illustrated in FIG. 4, the terminal for transmitting and receiving data according to the exemplary embodiment of the present invention includes a sync controller 40, a transceiver 43, a memory 44, and a display 45. The sync controller 40 includes a status recorder 41 and a flag reader 42.

The sync controller 40 performs a function for configuring a user interface (UI) using data provided by a mobile communication provider. For this, the sync controller 40 requests a server of the mobile communication provider to transmit data configuring the user interface. The sync controller 40 can configure the user interface of the terminal by receiving the requested data. Here, the term “sync” can refer to a process for receiving the data required to configure the user interface.

According to an exemplary embodiment of the present invention, the sync controller 40 uses a flag prepared for a failure of a power supply during a synchronization process between the terminal and the server of the mobile communication provider. The failure of the power supply can be caused by forced power-off by a user, power supply interruption by impact, power supply instability by a malfunction of the terminal, or the like.

The status recorder 41 performs a function for recording a flag indicating a progress status of the synchronization process and the flag reader 42 causes an interrupted synchronization process to be resumed by reading the flag recorded in the memory 44.

The transceiver 43 performs a function for transmitting a signal for requesting the server of the mobile communication provider to transmit data and receiving the data from the server of the mobile communication provider. The transceiver 43 can be connected to an antenna, if needed.

The memory 44 stores the flag recorded by the status recorder 41. The flag can be configured with a combination of a small number of bits or a specific code. The memory 44 can use both an internal memory and an external memory, and is not limited to a specific memory such as a flash memory or a hard disk.

In this regard, the memory 44 can be an electrically erasable and programmable read only memory (EEPROM) or flash memory such that the flag can be stably stored irrespective of whether the power is on or off.

The display 45 performs a function for displaying a user interface processed by the sync controller 40. The display 45 can be realized by a liquid crystal display (LCD) or organic light emitting diodes (OLED). The display 45 can display not only the user interface based on the data received from the server of the mobile communication provider but also information necessary for an operation of the terminal and various functions.

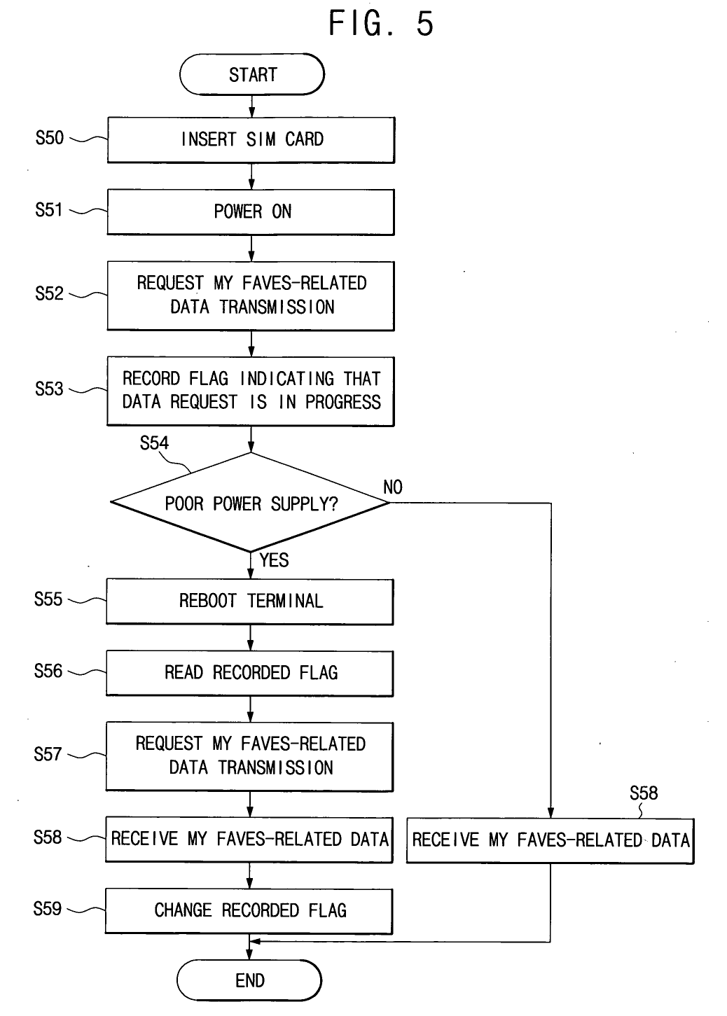

FIG. 5 is a flowchart illustrating a method for transmitting and receiving data to prepare for a poor power supply according to an exemplary embodiment of the present invention.

With the development of technology, new services will be provided such that a user interface of a terminal can be configured with data received from a server of a mobile communication provider and a user interface configured by a terminal user can be manipulated.

For a better understanding of the present invention, an example of a myFaves service currently being provided by the mobile communication provider is illustrated in FIG. 5.

A SIM of a subscriber (user) joining the myFaves service is inserted into a terminal capable of using the myFaves service (S50).

After the SIM is inserted (S50), the user turns on a power supply (S51). Then, data can be transmitted and received between the terminal and the server of the mobile communication provider. Subscriber information included in the SIM is used to retrieve data related to My Faves registered by the subscriber from the server of the mobile communication provider.

In a state in which data transmission and reception are possible, the sync controller 40 transmits a signal for requesting data required to configure a user interface according to the myFaves service to the server of the mobile communication provider (S52). In a T-mobile service protocol provided by the T-mobile company, the data transmission request signal sent to the server of the mobile communication provider is referred to as a sync session setup request signal. The sync session setup request signal is used to request the transmission of data related to My Faves registered by the subscriber.

When the sync session setup request signal is transmitted, the status recorder 41 records a flag indicating a current progress status of a synchronization process (S53). Specifically, the flag can be recorded in an area of the memory 44 in which data is not lost irrespective of whether power of the terminal is on or off. When the flag is recorded, status=UNDER_SYNC; or a combination of specific bits can be recorded.

The terminal can be powered off when the power supply of the terminal is abnormal during reception of a SyncSrv message (including data related to My Faves registered by the subscriber) in response to the sync session setup request of the sync controller 40 (S54). When the terminal is powered off, the reception of the SyncSrv message is interrupted and a problem occurs when configuring the user interface of the terminal. When the terminal reboots (S55), the flag reader 42 reads a flag recorded by the status recorder 41 from the memory 44 (S56).

When a sync session setup request is in progress, the current status of the flag recorded in the memory 44 can indicate that the sync session setup request is in progress since the progress status flag is recorded. Accordingly, since the sync controller 40 can determine that the SyncSrv message reception process has not been normally performed, the sync session setup request can be retransmitted (S57).

When the SyncSrv message is normally received from the server of the mobile communication provider in response to the sync session setup request of step S57 (S58), a flag status recorded in the memory 44 is changed to indicate that the reception process has been normally performed (S59).

Accordingly, it is possible to address a problem that My Faves registered by the user are not displayed on the user interface of the terminal even when the user terminal reboots in a state in which the power supply is abnormal during reception of the SyncSrv message. It is possible to prevent in advance a trouble that the terminal user should again receive the SyncSrv message after retrieving a refresh item from a menu.

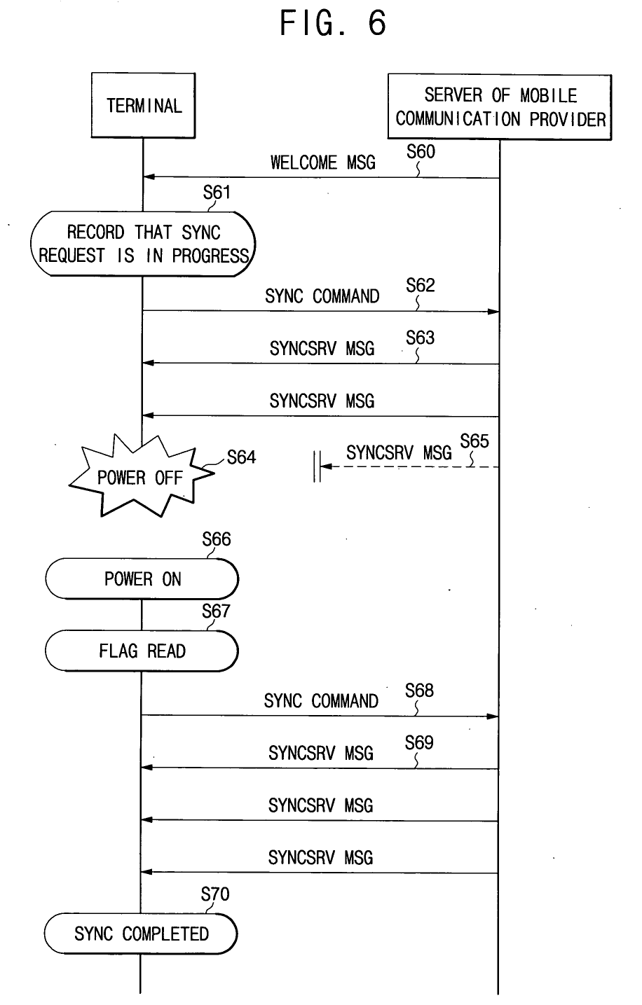

FIG. 6 illustrates an example when the power supply is abnormal during reception of My Faves-related data according to an exemplary embodiment of the present invention.

When the terminal is powered on after a SIM of the terminal user is inserted thereinto, a Welcome message indicating that a connection to the server of the mobile communication provider has been established is received (S60). Upon determining that the connection to the server of the mobile communication provider has been established, the terminal records a flag indicating that a sync session setup request is in progress (S61) when a Sync Command message for the sync session setup request is transmitted (S62).

In FIG. 6, different from FIG. 5, the flag record process S61 is shown before the Sync Command message transmission process S62. The temporal relationship between the processes does not affect a feature of the present invention. The flag record process can be performed after the Sync Command message transmission process, and can be performed simultaneously with the Sync Command message transmission process.

In response to the terminal's sync session setup request of step S62, a SyncSrv message is transmitted from the server of the mobile communication provider to the terminal (S63). When the terminal is powered off by battery discharge or sudden impact applied thereto (S64), a SyncSrv message reception process can be stopped (S65).

When the terminal user boots the terminal by applying power thereto, the flag reader 42 can determine that the sync session setup request has been made and the SyncSrv message has not been normally received in response thereto through a flag read process of the flag reader 42 (S67). Accordingly, the sync controller 40 retransmits a sync session setup request signal (S68) and receives the SyncSrv message (S69), thereby performing the synchronization process of the terminal (S70).

According to the method for transmitting and receiving data to prepare for a poor power supply, there is provided a service for configuring a user interface of a terminal based on data provided by a mobile communication provider. In order to prevent the user interface from being incompletely configured due to the poor power supply upon data reception, a flag indicating a progress status is recorded when a data transmission request is sent from the terminal to a server of the mobile communication provider. The user interface can be normally implemented and displayed by automatically performing a data reception process after reading the recorded status flag without an additional operation of the terminal user even when the power supply of the terminal is abnormal and the terminal reboots, thereby preventing in advance a problem occurring due to a terminal malfunction and eliminating a trouble that the user has to perform a special refresh operation to address the problem. In viewpoint of the mobile communication provider, the number of customers requesting compensations or repairs due to a problem of a poor power supply in implementing the user interface can be reduced and the service can be cost-effectively provided.

The specific terms and descriptions should not be construed as limiting the scope of the invention.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting and receiving data to prepare for a poor power supply of a terminal configuring a user interface by referring to data provided by a mobile communication provider, comprising the steps of:
recording a status flag indicating that a data request signal transmission is in progress when a data request signal required to configure the user interface is transmitted; and
determining whether to retransmit the data request signal by reading the status flag and receiving requested data when the power supply of the terminal is interrupted and resumed during data reception in response to the data request signal.

2. The method of claim 1, wherein the status flag is recorded in a memory area that retains the status flag even after the terminal is powered off.

3. The method of claim 1, further comprising the step of:
changing the recorded status of the status flag by reflecting a data reception completion state when the requested data is completely received.

4. The method of claim 1, wherein the data configuring the user interface relates to phone numbers to which a user of the terminal frequently makes a call.

5. The method of claim 1, wherein the user interface displays an image of another party registered with a phone number to which a mobile communication service subscriber frequently makes a call on an idle screen of the terminal, and the displayed image being changed or updated by an input of the subscriber.

6. A mobile communication terminal for configuring a user interface using data provided by a mobile communication provider, comprising:
a sync controller that records a status flag indicating that data request signal transmission is in progress when a data request signal required to configure the user interface is transmitted and determines whether to retransmit the data request signal by referring to the status flag when a power supply of the terminal is interrupted and resumed during data reception in response to the data request signal; and
a memory that stores the status flag under control of the sync controller.

7. The mobile communication terminal of claim 6, wherein the sync controller includes:
a status recorder that records the status flag indicating that the data request signal transmission is in progress when the data request signal for configuring the user interface is transmitted; and
a flag reader that reads, upon resumption of the power supply, the status flag to detect how far the configuring process proceeded before interruption of the power supply occurred during data reception in response to the data request signal.

8. The mobile communication terminal of claim 6, wherein the memory is a nonvolatile memory that is retains the status flag even when the terminal is powered off.

9. The mobile communication terminal of claim 6, wherein the sync controller changes the recorded status of the status flag when the user interface is normally implemented by receiving the data required to configure the user interface.

10. The mobile communication terminal of claim 6, wherein the data configuring the user interface relates to phone numbers to which a user of the terminal frequently makes a call.

11. The mobile communication terminal of claim 10, wherein the data configuring the user interface relates to phone numbers in a user interface service.

12. The mobile communication terminal of claim 6, wherein the user interface service displays an image of another party registered with a phone number to which a mobile communication service subscriber frequently makes a call on an idle screen of the terminal, and the displayed image being changed or updated by an input of the subscriber.

13. A method for configuring a user interface using data provided by a mobile communication provider, comprising:
recording a status flag indicating that a data request signal transmission is in progress when a data request signal required to configure a user interface of a mobile communication terminal is transmitted; and
when a power supply of the mobile communication terminal is interrupted and resumed during a data reception in response to the data request signal, determining whether to retransmit the data request signal by referring to the status flag; and
when the data request signal is retransmitted, configuring a user interface by receiving requested data.

14. The method of claim 13 further comprising:
recording the status flag indicating that the data request signal transmission is in progress when the data request signal for configuring the user interface is transmitted; and
upon resumption of the power supply, reading the status flag to determine how far the configuring process proceeded before the interruption of the power supply occurred during the data reception in response to the data request signal.

15. The method of claim 13, wherein the memory is a nonvolatile memory that retains the status flag even when the terminal is powered off.

16. The method of claim 13 further comprising:
changing the recorded status of the status flag upon receiving the data required to configure the user interface.

17. The method of claim 13, wherein data configuring the user interface relates to phone numbers to which a user of the terminal frequently makes a call.

18. The method of claim 17, wherein the data configuring the user interface is relates to phone numbers in a MyFaves user interface service.

19. The method of claim 13 further comprising:
displaying an image of another party registered with a phone number to which a mobile communication service subscriber frequently makes a call on an idle screen of the terminal, and
changing the displayed image by an input of the subscriber.
